(19) United States
(12) Patent Application Publication
(10) Pub. No.: US 2004/0125992 A1
(43) Pub. Date: Jul. 1, 2004

(54) Image extraction method and authentication apparatus

(75) Inventors: Takahiro Aoki, Kawasaki (JP); Morito Shiohara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/628,477

(22) Filed: Jul. 29, 2003

(30) Foreign Application Priority Data
Aug. 30, 2002 (JP) 2002-255922

(51) Int. Cl. G06K 9/00; G06K 9/34; G06K 9/46

(52) U.S. Cl. 382/118; 382/173; 382/191

(57) ABSTRACT

An image extraction method picks up an image of an object positioned in front of a background using wavelengths in a visible light region, picks up an image of the object positioned in front of the background using wavelengths in an infrared region, and extracts only the object based on the picked up images. At least a surface of the background is formed by an organic dye.

This application claims the benefit of a Japanese Patent Application No.2002-255922 filed Aug. 30, 2002, in the Japanese Patent Office, the disclosure of which is hereby incorporated by reference.

### BACKGROUND OF THE INVENTION

1. Field of the Invention

The present invention generally relates to image extraction methods and authentication apparatuses, and more particularly to an image extraction method which is suited for extracting an object such as a person from an image which is picked up by removing the background, and to an authentication apparatus which uses such an image extraction method.

2. Description of the Related Art

In image processing such as an image combining process and a personal authentication process, an extraction of an object such as a person from an image is frequently carried out. For example, as a method of extracting only the person by removing the background from the image which is picked up, there is a method which uses a blue background. The human body does not include the blue color. For this reason, when the image of a person is picked up using the blue background and the blue region is removed from the picked up image, it is possible to remove the background from the picked up image and extract the person's face or the like from the picked up image.

However, the method using the blue background employs an image separation method based on color, and can only be used under visible light. The visible light region is a wavelength band which is normally visible to the human eye, and the brightness easily changes depending on the weather, the state of illumination and the like. Hence, the image extraction accuracy is greatly affected by the brightness of the environment in which the image is picked up when using the blue background. It is conceivable to control the brightness of the environment in which the image is picked up by use of illumination or the like, however, the illumination may be dazzling.

On the other hand, the infrared region is a wavelength band not visible to the human eye. Since the normal illumination or the like includes only very small amounts of components in the infrared region if any, the image extraction accuracy is not greatly affected by the brightness of the environment in which the image is picked up when extracting the object from the image which is picked up using infrared ray. In addition, the infrared illumination is not dazzling because the infrared illumination is not visible to the human eye.

However, since the conventional image separation method using the blue background is intended for the image which is picked up with the wavelengths in the visible light region, there was a problem in that the image extraction accuracy is greatly affected by the brightness of the environment in which the image is picked up. In addition, when the image extraction accuracy deteriorates, there was a problem in that an authentication accuracy of an authentication apparatus which uses the extracted image also deteriorates.

On the other hand, when picking up the image with the wavelengths in the infrared region, the image extraction accuracy is not greatly affected by the brightness of the environment in which the image is picked up. However, there was a problem in that the image separation method using the blue background cannot be used because the image separation method is intended for the image picked up in the visible light region.

In order to improve the image extraction accuracy, it is conceivable to extract the object from the images picked up in the wavelengths of both the visible light region and the infrared region. But even in this conceivable case, the conventional image separation method using the blue background can only be used for the image separation with respect to the image which is picked up in the wavelengths of the visible light region, and cannot be used for the image separation with respect to the image which is picked up in the wavelengths of the infrared region. As a result, this conceivable method is not practical in that it is necessary to change the image pickup environment, that is, the background, between the image pickup in the wavelengths of the visible light region and the image pickup in the wavelengths of the infrared region.

### SUMMARY OF THE INVENTION

Accordingly, it is a general object of the present invention to provide a novel and useful image extraction method and authentication apparatus, in which the problems described above are eliminated.

Another and more specific object of the present invention is to provide an image extraction method and an authentication apparatus which can extract an object or the like from a picked up image with a high accuracy, using a relatively simple process and structure.

Still another object of the present invention is to provide an image extraction method comprising a first image pickup step to pick up an image of an object positioned in front of a background using wavelengths in a visible light region; a second image pickup step to pick up an image of the object positioned in front of the background using wavelengths in an infrared region; and an extracting step to extract only the object based on the images picked up by the first and second image pickup steps, wherein at least a surface of the background is formed by an organic dye. According to the image extraction method of the present invention, it is possible to extract the object from the picked up image with a high accuracy, using a relatively simple process and structure.

A further object of the present invention is to provide an authentication apparatus comprising a first image pickup section to pick up an image of an object positioned in front of a background using wavelengths in a visible light region; a second image pickup section to pick up an image of the object positioned in front of the background using wavelengths in an infrared region; an extracting section to extract only an image of the object based on the images picked up by the first and second image pickup sections; and a matching section to compare the image extracted by the extracting section and registered object images, and to output a result of comparison as an authentication result, wherein at least a surface of the background is formed by an organic dye. According to the authentication apparatus of the present invention, it is possible to extract the object from the picked up image with a high accuracy, using a relatively simple process and structure.

Other objects and further features of the present invention will be apparent from the following detailed description when read in conjunction with the accompanying drawings.

### BRIEF DESCRIPTION OF THE DRAWINGS

FIG. 1 is a diagram for explaining a first embodiment of an image extraction method according to the present invention;

FIGS. 2A and 2B are diagrams for explaining an image extraction from an image picked up by a visible light camera;

FIGS. 3A and 3B are diagrams for explaining an image extraction from an image picked up by an infrared camera;

FIG. 4 is a system block diagram showing a first embodiment of an authentication apparatus according to the present invention;

FIG. 5 is a flow chart for explaining a cut out process; and

FIG. 6 is a flow chart for explaining a matching process.

### DESCRIPTION OF THE PREFERRED EMBODIMENTS

A description will be given of various embodiments of an image extraction method and an authentication apparatus according to the present invention, by referring to the drawings.

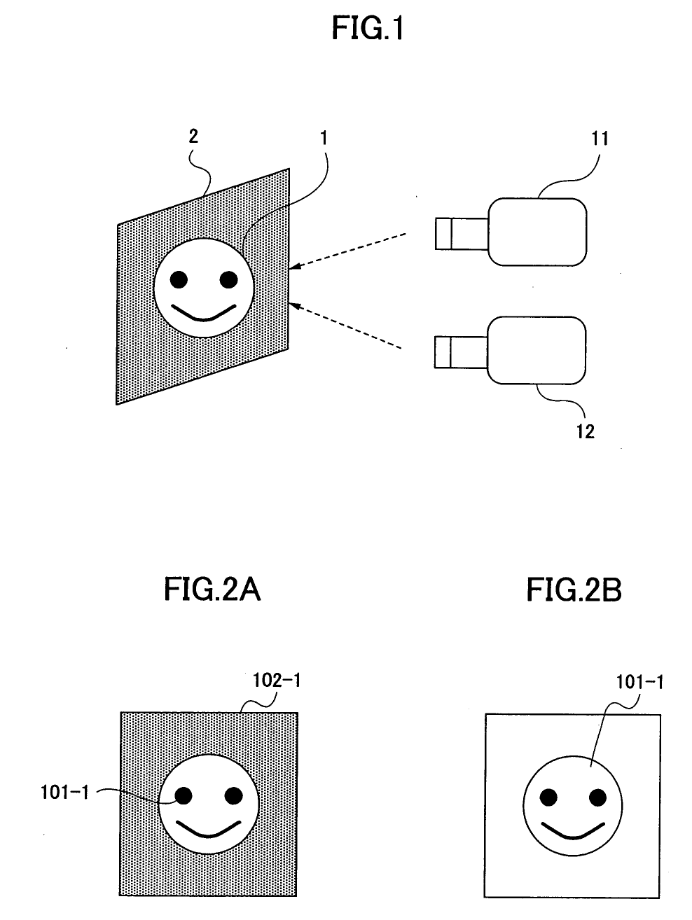

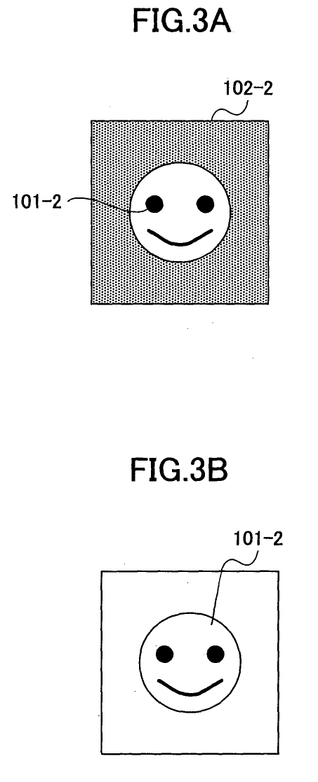

First, a description will be given of a first embodiment of the image extraction method according to the present invention, by referring to FIGS. 1 through 3B. FIG. 1 is a diagram for explaining this first embodiment of the image extraction method according to the present invention. FIGS. 2A and 2B are diagrams for explaining an image extraction from an image picked up by a visible light camera, and FIGS. 3A and 3B are diagrams for explaining an image extraction from an image picked up by an infrared camera.

In FIG. 1, an object 1 such as a face of a person, positioned in front of a background 2, is picked up by a visible light camera 11 and an infrared camera 12. At least a surface of the background 2 facing the object 1 is made of an organic dye used for a recording layer of a CD-R or the like. For example, the organic dye is coated on the surface of the background 2.

Various kinds of organic dyes, made up of various components, are used for the recording layer of the CD-R or the like. The color of the organic dye when viewed under visible light differs depending on the composition of the organic dye. For example, phthalocyanine organic dyes appear to be gold in color when viewed under visible light, azo organic dyes appear to be silver in color when viewed under visible light, and cyanine organic dyes appear to be blue in color when viewed under visible light. For example, the color of the cyanine organic dye is not included in the human body, and thus, by using the background 2 having the surface which is coated with the cyanine organic dye, it is possible to obtain effects which are similar to those obtainable by the conventional image separation method using the blue background. In other words, when the surface of the background 2 is coated with the cyanine organic dye and the object 1 in front of the background 2 is picked up with the wavelengths in the visible light region using the visible light camera 11, it is possible to cut out the background 2 from the picked up image and extract the object 1 from the picked up image, similarly to the case where the blue background is used. In addition, when extracting a target object from the picked up image, it is possible to similarly extract the target object by changing the kind of organic dye which is coated on the surface of the background 2 depending on the color of the target object.

On the other hand, the organic dye has a characteristic which absorbs the infrared ray, and particularly the near-infrared ray. This is because, a wavelength of a laser beam used for the signal recording and/or reproduction on and/or from the CD-R or the like is approximately 800 nm, and the organic dye used for the recording layer of the CD-R or the like is designed to absorb the infrared ray having wavelengths in a vicinity of the wavelength of the laser beam. Accordingly, when the organic dye is picked up by the infrared camera 12 in the wavelengths of the infrared region, the organic dye appears to be black because the organic dye absorbs the infrared ray. For this reason, when the surface of the background 2 is coated with the cyanine organic dye and the object 1 in front of the background is picked up by the infrared camera 12 in the wavelengths of the infrared region, the background 2 appears black or dark in the picked up image, and the object 1 can be extracted by cutting out the black or dark portion from the picked up image.

FIG. 2A shows the image which is picked up by the visible light camera 11. In this picked up image, an image portion 102-1 corresponding to the background 2 has a blue-green color with respect to an image portion 101-1 corresponding to the object 1. Hence, by cutting out the blue-green image portion 102-1 similarly to the case where the blue background is used, based on the color of the image portion 102-1, it is possible to extract the image portion 101-1 of the object 1 as shown in FIG. 2B.

FIG. 3A shows the image which is picked up by the infrared camera 12. In this picked up image, an image portion 102-2 corresponding to the background 2 has a black or dark color with respect to an image portion 101-2 corresponding to the object 1. Hence, by cutting out the black or dark colored image portion 102-2, based on the luminance of the image portion 102-2, it is possible to extract the image portion 101-2 of the object 1 as shown in FIG. 3B.

The extraction accuracy of the image extracted image portion 101-1 shown in FIG. 2B is affected by the brightness of the environment in which the image shown in FIG. 2A is picked up, but the extracted image portion 101-1 may include color information. On the other hand, the extracted image portion 101-2 shown in FIG. 3B cannot include color information, but the extraction accuracy of the extracted image portion 101-2 is uneasily affected by the brightness of the environment in which the image shown in FIG. 3A is picked up. Hence, it is possible to switch the extracted image portion 101-1 and the extracted image portion 101-2 to be used depending on the environment, the requested color information or the like, and to combine the extracted image portion 101-1 and the extracted image portion 101-2 so as to improve the extraction accuracy. Particularly when the extracted image portion is used for processes such as an authentication process which will be described later, it is possible to improve the authentication accuracy by comparing a reference image portion with both the extracted image portion 101-1 and the extracted image portion 101-2.

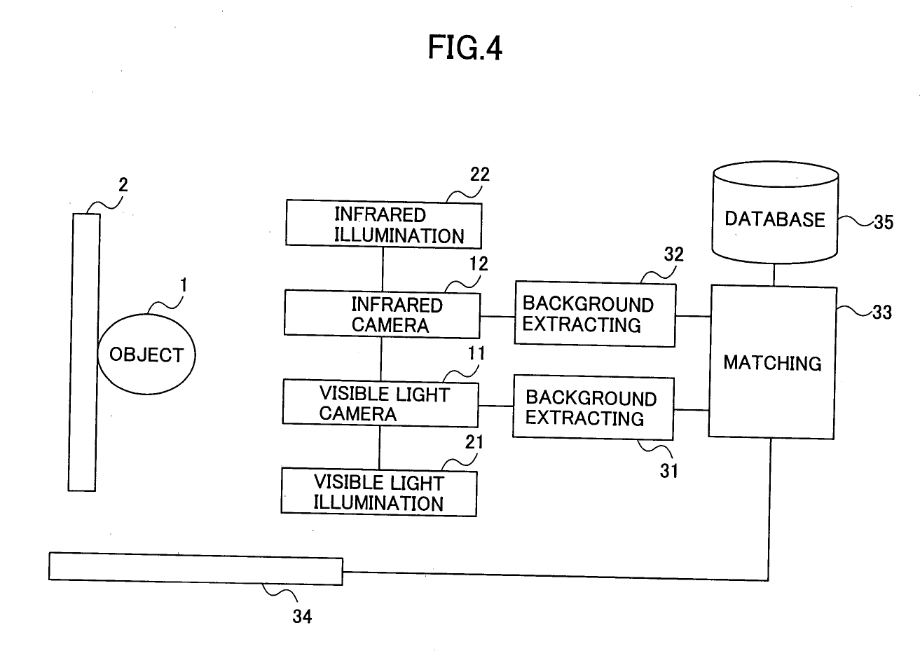

Next, a description will be given of a first embodiment of the authentication apparatus according to the present invention, by referring to FIGS. 4 through 7. This first embodiment of the authentication apparatus employs the first embodiment of the image extraction method. In this embodiment, it is assumed for the sake of convenience that the authentication apparatus is used to restrict entry into a room.

FIG. 4 is a system block diagram showing the first embodiment of the authentication apparatus. In FIG. 4, those parts which are the same as those corresponding parts in FIG. 1 are designated by the same reference numerals, and a description thereof will be omitted. The authentication apparatus shown in FIG. 4 includes the visible light camera 11, the infrared camera 12, a visible light illumination 21, an infrared illumination 22, background cut out sections 31 and 32, a matching section 33, a door key 34, and a personal information database 35.

The visible light illumination 21 is turned ON if necessary so as to obtain an illumination environment suited for picking up the image of the object 1 by the visible light camera 11. The infrared illumination 22 is turned ON if necessary so as to obtain an illumination environment suited for picking up the image of the object 1 by the infrared camera 12. The visible light illumination 21 and/or the infrared illumination 22 may be omitted.

The background cut out section 31 cuts out the image portion 102-1 corresponding to the background 2 based on the color, from the image shown in FIG. 2A which is picked up by the visible light camera 11, so as to extract the image portion 101-1 corresponding to the object 1 shown in FIG. 2B. The background cut out section 32 cuts out the image portion 102-2 corresponding to the background 2 based on the brightness, from the image shown in FIG. 3A which is picked up by the infrared camera 12, so as to extract the image portion 101-2 corresponding to the object 1 shown in FIG. 3B. The extracted image portion 101-1 from the background cut out section 31 and the extracted image portion 101-2 from the background cut out section 32 are supplied to the matching section 33.

The matching section 33 decides whether or not one of the image portions 101-1 and 101-2 supplied from the background cut out sections 31 and 32 matches a reference image portion which is registered in the personal information database 35, so as to judge whether or not the object 1 is a user who is registered in advance in the personal information database 35. When the matching section 33 judges that a matching reference image portion is not registered in the personal information database 35, the matching section 33 records the image portions 101-1 and 101-2 supplied from the background cut out sections 31 and 32 as logs. In this case, the door key 34 is locked, and the user is not permitted to enter the room. On the other hand, when the matching section 33 judges that a matching reference image portion is registered in the personal information database 35, the matching section 33 supplies a match signal to the door key 34. The door key 34 is opened in response to the match signal, and the user is thus permitted to enter the room.

The personal information database 35 may be a part of the authentication apparatus or, an external database which is accessible from the authentication apparatus.

The background cut out sections 31 and 32 and the matching section 33 may be realized by a central processing unit (CPU) of a general purpose computer system.

Of course, when the matching section 33 judges that a matching reference image portion is not registered in the personal information database 35, the matching section 33 may supply a disagreement signal to the door key 34. In this case, it is possible to turn ON a lamp which is connected to the door key 34 or, display a message on a display section, in response to the match signal and/or the disagreement signal, so as to indicate that the user is permitted to enter the room and/or is not permitted to enter the room.

The authentication apparatus is not limited to the application to restrict entry to the room. For example, the authentication apparatus may be applied to a computer system so as to restrict the use of the computer system. In this case, the match signal and/or the disagreement output from the matching section 33 may be used to trigger an access restriction of the computer system, a display of access enabled state of the computer system, a display of access disabled state of the computer system, and the like.

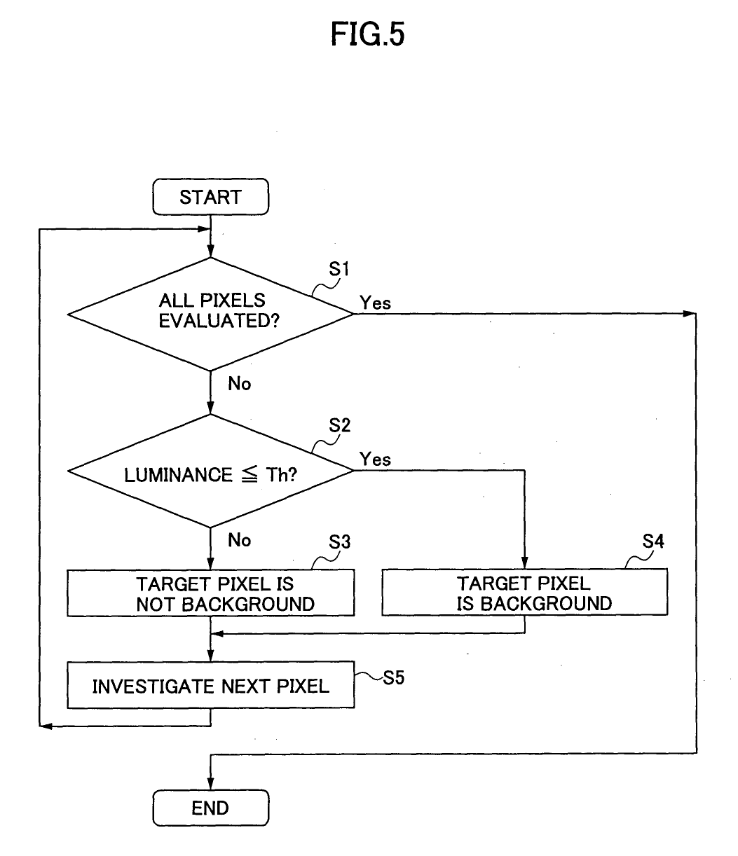

FIG. 5 is a flow chart for explaining a cur out process of the background cut out section 32. In FIG. 5, a step S1 decides whether or not all pixels within the image shown in FIG. 3A which is supplied from the infrared camera 12 are evaluated, and the process ends if the decision result in the step S1 is YES. On the other hand, if the decision result in the step S1 is NO, a step S2 decides whether or not a luminance of a target pixel within the image is less than or equal to a predetermined threshold value Th. If the decision result in the step S2 is NO, a step S3 judges that the target pixel is not the image portion 102-2 corresponding to the background 2, and the process advances to a step S5 which will be described later. If the decision result in the step S2 is YES, a step S4 judges that the target pixel is the image portion 102-2 corresponding to the background 2, and the process advances to the step S5.

The step S5 investigates a next pixel within the image, and the process returns to the step S1. If the decision result in the step S1 is NO, the step S2 and the subsequent steps are carried out by regarding the next pixel as the target pixel.

The cut out process itself of the background cut out section 31 can be carried out by a known method, and a description thereof will be omitted. The background cut out section 31 can carry out a process similar to that shown in FIG. 5, for example, with respect to the image shown in FIG. 2A which is supplied from the visible light camera 11. In this case, however, a step corresponding to the step S2 decides whether or not the color of the target pixel is a predetermined color (blue-green color in this particular case), instead of deciding whether or not the luminance of the target pixel is less than or equal to the predetermined threshold value Th.

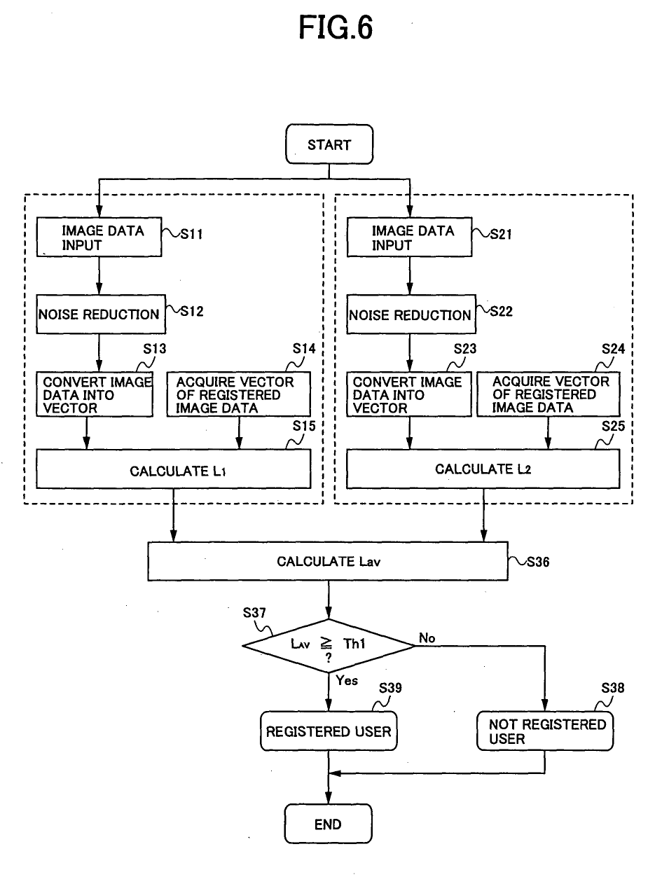

FIG. 6 is a flow chart for explaining a matching process of the matching section 33. In FIG. 6, steps S11 through S15 which are carried out with respect to the image data of the image portion 101-1 corresponding to the object and supplied from the visible light camera 11, and steps S21 through 25 which are carried out with respect to the image data of the image portion 101-2 corresponding to the object 1 and supplied from the infrared camera 12, are carried out in parallel.

The step S11 inputs the image data of the image portion 101-1 corresponding to the object 1 supplied from the visible light camera 11, and the step S12 carries out a known noise reduction process with respect to the input image data. The step S13 converts the image data obtained by the step S12 into a vector. In addition, the step S14 acquires a vector of the image data corresponding to a registered reference image portion which matches the input image data and is read from the personal information database 35. The registered reference image portion which matches the input image data and is read from the personal information database 35 need not perfectly match the input image data, and may match the input image data within a predetermined (or tolerable) range. The step S15 calculates a distance L1 between the vector obtained by the step S13 and the vector obtained by the step S14, and the process advances to a step S36 which will be described later.

On the other hand, the step S21 inputs the image data of the image portion 101-2 corresponding to the object 1 supplied from the infrared camera 12, and the step S22 carries out a known noise reduction process with respect to the input image data. The step S23 converts the image data obtained by the step S22 into a vector. In addition, the step S24 acquires a vector of the image data corresponding to a registered reference image portion which matches the input image data and is read from the personal information database 35. The registered reference image portion which matches the input image data and is read from the personal information database 35 need not perfectly match the input image data, and may match the input image data within a predetermined (or tolerable) range. The step S25 calculates a distance L2 between the vector obtained by the step S23 and the vector obtained by the step S24, and the process advances to the step S36 which will be described later.

The vector of the image data corresponding to the registered reference image portion may be stored in the personal information database 35. Alternatively, the image data corresponding to the registered reference image portion may be stored in the personal information database 35, and this image data read from the personal information database 35 may be converted into a vector in the steps S14 and S24, similarly to the steps S13 and S23.

The step S36 calculates an average Lav of the distance L1 calculated in the step S15 and the distance L2 calculated in the step S25. A step S37 decides whether or not the average Lav is greater than or equal to a threshold value Th1. If the decision result in the step S37 is NO, a step S38 judges that the object 1 is not the registered user who is registered in advance in the personal information database 35, outputs the disagreement signal described above if necessary, and the process ends. On the other hand, if the decision result in the step S37 is YES, a step S39 judges that the object 1 is the registered user who is registered in advance in the personal information database 35, outputs the match signal described above, and the process ends.

By changing the color of the background 2 depending on the image which is to be picked up and the object 1 which is to be extracted from the picked up image, it is possible to extract the object 1 from the image which is picked up by the visible light camera 11 by the background cut out section 31 using a known method. Hence, by forming at least the surface of the background 2 by the organic dye having an appropriate color, it is possible to similarly extract the object 1 from the image which is picked up by the infrared camera 12 by the background cut out section 32 using the method described above.

Therefore, according to the present invention, it is possible to simultaneously pick up the image of the object in two different wavelengths, namely, the wavelengths of the visible light region and the wavelengths of the infrared region. For this reason, it is possible to extract only the object from the picked up image with a high accuracy. Moreover, since it is possible to utilize the two different wavelengths, namely, the wavelengths of the visible light region and the wavelengths of the infrared region, it is possible to improve the reliability of the authentication apparatus by applying the present invention to the authentication apparatus.

Further, the present invention is not limited to these embodiments, but various variations and modifications may be made without departing from the scope of the present invention.

What is claimed is:

1. An image extraction method comprising:
a first image pickup step to pick up an image of an object positioned in front of a background using wavelengths in a visible light region;
a second image pickup step to pick up an image of the object positioned in front of the background using wavelengths in an infrared region; and
an extracting step to extract only the object based on the images picked up by the first and second image pickup steps,
wherein at least a surface of the background is formed by an organic dye.

2. The image extraction method as claimed in claim 1, wherein said extracting step extracts the object from the image picked up by the first image pickup step depending on color, and extracts the object from the image picked up by the second image pickup step depending on luminance.

3. The image extraction method as claimed in claim 1, wherein said organic dye has a color selected from a group consisting of blue-green color, gold color and silver color.

4. The image extraction method as claimed in claim 1, wherein said organic dye is selected from a group consisting of cyanine organic dyes, phthalocyanine organic dyes, and azo organic dyes.

5. An authentication apparatus comprising:
a first image pickup section to pick up an image of an object positioned in front of a background using wavelengths in a visible light region;
a second image pickup section to pick up an image of the object positioned in front of the background using wavelengths in an infrared region;
an extracting section to extract only an image of the object based on the images picked up by the first and second image pickup sections; and
a matching section to compare the image extracted by the extracting section and registered object images, and to output a result of comparison as an authentication result,
wherein at least a surface of the background is formed by an organic dye.

6. The authentication apparatus as claimed in claim 5, wherein said extracting section extracts the image of the object from the image picked up by the first image pickup section depending on color, and extracts the image of the object from the image picked up by the second image pickup section depending on luminance.

7. The authentication apparatus as claimed in claim 5, wherein said matching section outputs the comparison result by comparing an average of the image of the object extracted by the extracting section from the image picked up by the first image pickup section and the image of the object extracted by the extracting section from the image picked up by the second image pickup section, and the registered object images.

8. The authentication apparatus as claimed in claim 5, wherein the organic dye has a color selected from a group consisting of blue-green color, gold color and silver color.

9. The authentication apparatus as claimed in claim 5, wherein the organic dye is selected from a group consisting of cyanine organic dyes, phthalocyanine organic dyes, and azo organic dyes.
